(19) United States
(12) Patent Application Publication
(10) Pub. No.: US 2013/0103741 A1
(43) Pub. Date: Apr. 25, 2013

(54) Access of external data for inclusion within document

(71) Applicants: Galo Gimenez Palop, Bigues I Riells (ES); Shane I. Saunders, Denver, CO (US)

(72) Inventors: Galo Gimenez Palop, Bigues I Riells (ES); Shane I. Saunders, Denver, CO (US)

(21) Appl. No.: 13/281,364

(22) Filed: Oct. 25, 2011

(51) Int. Cl. G06F 15/16

(52) U.S. Cl. 709/203

(57) ABSTRACT

A client computing device has a document-editing application program to edit a document. The document issues a request to access external data stored on an external source for inclusion within the document. A client-side external data component at the client computing device receives and routes the request to access the external data from the document and returns the external data responsively received to the request back to the document for inclusion within the document. A server-side external data component at a server computing device receives from the client-side external data component the request to access the external data, routes the request to the external source, and returns the external data responsively received to the request back to the client-side external data component.

### BACKGROUND

Document-editing application programs at the enterprise level permit users of an organization to collaboratively work on documents together. The documents can be live, or dynamic. That is, rather than having data that is manually input or entered by users, and which then have to be manually edited by the users to change the data, the documents can reference external data stored on external sources. As the external data on such external sources change, the documents correspondingly are updated, dynamically.

### BRIEF DESCRIPTION OF THE DRAWINGS

FIG. 1 is a diagram of an example system to access data for inclusion within a document.

FIG. 2 is a diagram of an example implementation of a server computing device having a server-side external data component.

FIGS. 3A, 3B, and 3C are diagrams of example implementations of a client computing device having a client-side external data component.

FIG. 4 is a flowchart of an example method to access data for inclusion within a document.

### DETAILED DESCRIPTION

As noted in the background section, document-editing application programs can provide for documents that are live or dynamic, by permitting the documents to reference external data stored on external sources. A problem is that many external sources of such data are legacy sources, which means that they do not interconnect well to more modern document-editing application programs. This limits the capabilities of such document-editing application programs, insofar as relatively large sources of external data may not be able to be included within documents edited and created within such application programs.

Disclosed herein are techniques that permit external sources of external data to be accessible within documents of document-editing application programs, even where these external sources are legacy sources of such data. A system includes a client computing device and a server computing device. A document-editing application program runs on the client computing device for editing a document. The client computing device includes a client-side external data component, and the server computing device includes a server-side external data component, to permit the document to access external data stored on an external source for inclusion within the document.

The document issues a request to access the external data. The client-side external data component receives and routes the request, and returns the external data responsively received back to the document for inclusion therein. The server-side external data component receives the request from the client-side external data component, routes the request to the external source, and returns the external data received from the external source back to the client-side external data component.

For instance, the server-side external data component can include a data access module for the external source and that is instantiated in relation to the client computing device to perform this functionality. The client-side external data component can be directly embedded within the document-editing application program itself. The client-side external data component may also be a proxy component that is internal or external to the document-editing application program, or a library of function calls that the document utilizes to access the external data.

By dividing the external data access over a client-side external data component and a server-side external data component, various advantages can be realized. The client-side external data component is sufficiently general that when a new external source of external data is to be accessed, the client-side external data component does not have to be rewritten and/or updated at the client computing device. Rather, for example, a new data access module just has to be written and instantiated for documents to access the external data at this new external source. As such, management of client computing devices is made easier as compared to having to rewrite and roll out an updated document-editing application program to each client computing device as new external sources of external data are to be accessed.

Furthermore, security is improved, because access to external sources of external data occurs through the server-side external data component, such as data access modules thereof. Rogue requests and replies regarding external data stored at external sources can be processed at the server computing device, ensuring that some type of centralized management occurs, instead of client computing devices directly accessing the external sources themselves. That is, appropriate firewalling and other security methodologies can be implemented at the server level, instead of at the client level.

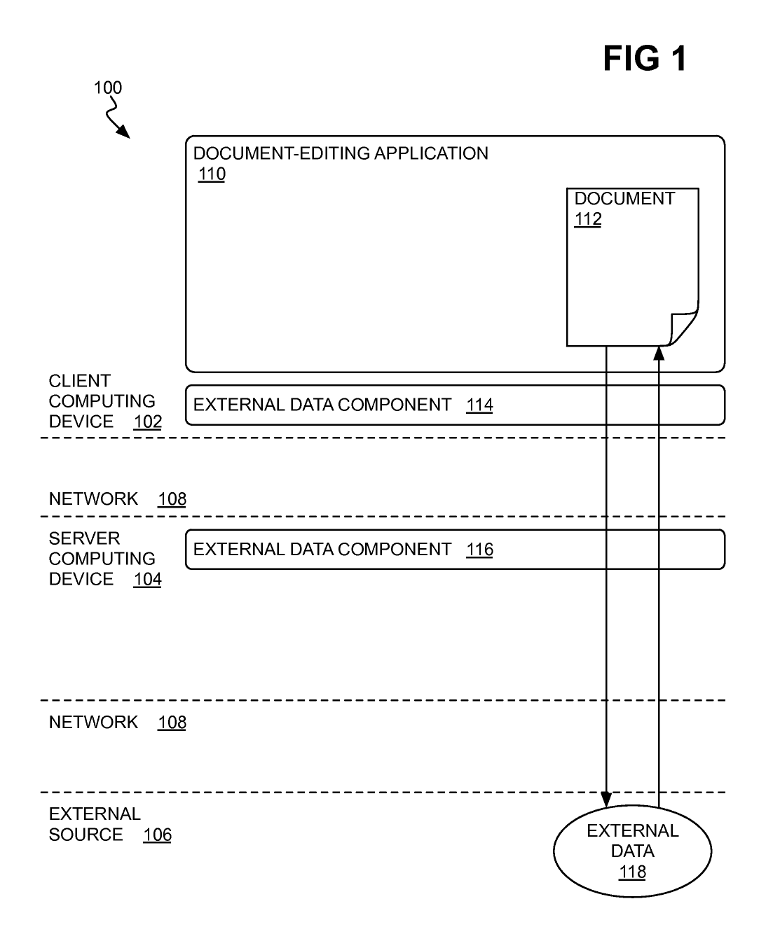

FIG. 1 shows an example system 100. The system 100 includes a client computing device 102, a server computing device 104, and an external source 106, which are communicatively interconnected to one another via a network 108. The client computing device 102 and the server computing device 104 can each be a computer, such as a desktop computer or a laptop computer particularly in the case of the client computing device 102. There may be more than one computing device 102 communicatively interconnected to the same server computing device 104.

The network 108 that communicatively interconnects the client computing device 102 and the server computing device 104 in the example of FIG. 1 is the same network 108 that communicatively interconnects the server computing device 104 and the external source 106. However, these two networks 108 may be different networks in another implementation. The network 108 may be or include the Internet, an intranet, an extranet, a local-area network (LAN), a wide-area network (WAN), a wired network, a wireless network, and so on.

The client computing device 102 has at least two types of software that run on the computing device 102: a document-editing application 110 and a client-side external data component 114. The document-editing application 110 is an application computer program that permits the creation and editing of live documents, such as a document 112 as in the example of FIG. 1. Examples of such documents include word processing documents, spreadsheet documents, and so on. The document-editing application 110 may be an enterprise-level document-editing application computer program, such as the Exstream software available from Hewlett-Packard Company, of Palo Alto, Calif.

The server computing device 104 has at least one type of software that runs on the computing device 104: a corresponding server-side external data component 116. The external source 106 may be a server computing device as well. In the example of FIG. 1, the external source 106 is a different server computing device than the server computing device 104, but in a different implementation, the external source 106 may be implemented on the server computing device 104. In this case, the network 108 that communicatively interconnects the server computing device 104 to the external source 106 is not present.

The external source 106 stores external data 118 that a user may desire to include as part of the document 112 within the document-editing application 110. The external source 106 may be a legacy product with which the document-editing application 110 does not have any built-in functionality to access the external data 118 stored on the external source 106. Examples of such an external source 106 include an external data source that is accessed in accordance with a Java® Database Connectivity (JDBC) methodology, where Java® is a registered trademark of Oracle Corp., of Redwood Shores, Calif., as well as an external data source that is an SAP data source, using software available from SAP AG, of Walldorf, Germany. Examples of such external data 118 include customer records, product records, and so on.

The external data components 114 and 116 interact with one another to provide the document 112 within the document-editing application 110 access to the external data 118, in general, as follows. The document 112 issues a request for the external data 118 stored on the external source 106. The client-side external data component 114 receives the request and routes the request to the server-side external data component 116. The server-side external data component 116 routes the request to the external source 106, which returns the requested external data 118 to the server-side external data component 116. The server-side external data component 116 receives the external data 118 from the external source 106, and returns the external data 118 to the client-side external data component 114. The client-side external data component 114 likewise receives the external data 118 from the server-side external data component 116, and returns the external data 118 to the document 112.

Note, then, that the document 112, and thus the document-editing application 110 and the client computing device 102, do not directly interact with the external source 106 to receive the external data 118. Rather, the client-side external data component 114 interacts with the server-side external data component 116, which itself interacts with the external source 106 to receive the external data 118. As such, should a document 112 wish to receive external data 118 from a new external source 106, the document-editing application 110 and the client-side external data component 114 do not have to be redeveloped, or updated, to provide for this functionality. Rather, just the external data component 116 has to, which is typically easier to manage within a large organization, because a given server computing device 104 usually is communicatively interconnected with hundreds if not thousands of client computing devices 102.

Furthermore, this lack of direct interaction between the document 112, the document-editing application 110, and the client computing device 102 with the external source 106 means that security of communicative interaction with the external source 106 can be achieved at the level of the server computing device 104, instead of individually at each client computing device 102. Appropriate functionality can be added or configured at the server computing device 104 to ensure that the external data 118 is not malicious, for instance, as well as that the external source 106 is not nefarious. As before, because a given server computing device 104 is usually communicatively interconnected with hundreds if not thousands of client computing devices 102, security management is more easily achieved at the server computing device 104 than at each individual client computing device 102.

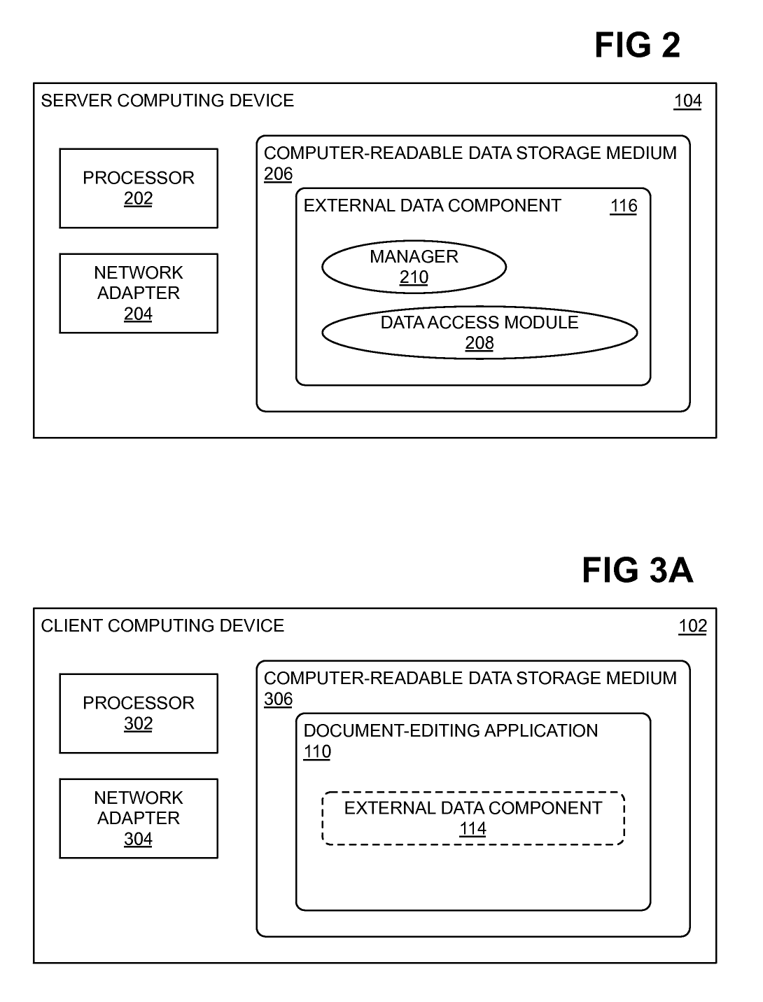

FIG. 2 shows an example implementation of the server computing device 104. The example server computing device 104 includes a processor 202, a network adapter 204, and a computer-readable data storage medium 206. The server computing device 104 can and typically does include other hardware, in addition and/or in lieu of the processor 202, the network adapter 204, and the computer-readable data storage medium 206.

The network adapter 204 permits the server computing device 104 to communicate over the network 108 of FIG. 1. The computer-readable data storage medium 206 may be a non-volatile or a volatile non-transitory computer-readable data storage medium, such as dynamic random access memory, hard disk drives, solid state drives, and so on. The computer-readable data storage medium 206 stores the server-side external data component 116, which is implemented as software that the processor 202 executes from the medium 206.

The server-side external data component 116 in the example implementation of FIG. 2 includes a data access module 208 and a data access module manager 210. The data access module 208 can be specific to and for the external source 106, and not for any other external sources of external data. The data access module 208 performs the functionality ascribed to the server-side external data component 116 that has been described in relation to FIG. 1 above. As such, the data access module 108 receives a request for the external data 118 from the client-side external data component 114, and routes this request to the external source 106. The data access module 108 receives the external data 118 from the external source 106 in response, and returns the external data 118 to the client-side external data component 114.

In one example implementation, the data access module 208 is instantiated from a general class or type of such a data access module 208 particularly for or in relation to the client computing device 102, and not in relation to other client computing devices 102 requesting the same external data 118 stored on the same external source 106. This means that in this implementation a different instance of the same data access module 208 is instantiated for each client computing device 102 that is to access the external data 118. Having separate instances of the same data access module 208 for multiple client computing device 102, as to the same external source 106, also provides for security benefits, at least because access by one client computing device 102 for the external data 118 is isolated, or sandboxed, from access by another client computing device 102 for the same external data 118 stored on the same external source 106.

The data access module manager 210 thus is responsible for managing each data access module 208. When the client computing device 102 makes a request for the external data 118 stored on the external source 106, if no instance of the data access module 208 for the external source 106 and in relation to the client computing device 102 is present, the data access module manager 210 instantiates such an instance. That is, even if an instance of the data access module 208 for the external source 106 exists for and in relation to another, different client computing device 102, another instance is still instantiated, so that each client computing device 102 has its own instance of the data access module 208 for the external source 106.

Furthermore, when the client computing device 102 is no longer accessing the external data 118 stored on the external source 106, the data access module manager 210 can terminate the instance of the data access module 208 for the external source 106 and that was instantiated for the client computing device 102. Because there is some processing overhead associated with instantiating and terminating instances, the data access module manager 210 may wait a predetermined length of time after the last access of the external data 118 by the client computing device 102 before terminating the instance of the data access module 208 in question. This predetermined length of time may be set statically, or may be dynamically adjusted based on the access history of the external data 118 by the client computing device 102.

Persisting the instance of the data access module 208 in relation to the client computing device 102 is also advantageous to ensure that if the access of the external data 118 over multiple requests is not stateless, the state of prior requests in a given access session of the data 118 can be more easily maintained. For example, a subsequent request for the external data 118 may rely on a prior request for the data 118 in some way. The state of the current session in which the client computing device 102 is accessing the external data 118 is more easily maintained where the instance of the data access module 208 is persisted throughout this session, as opposed to terminating the instance after each request for the data 118 has been fulfilled.

The example implementation of the server computing device 104 in FIG. 2 provides for a modular approach by which new external sources 106 of external data 118 can be accessed by the document 112, via generation of new data access modules 208 for the new external sources 106. For instance, when the data access module 210 is to instantiate a data access module 208, it may reference a library of existing classes or types of data access modules 210 to determine the appropriate data access module 208 to instantiate, based on the external source 106 that stores the external data 118 being requested. As such, new classes or types of data access modules 210 can be defined and added to this library so that new external sources 106 can be accessed by the document 112, without having to update the document-editing application 110 at the client computing device 102.

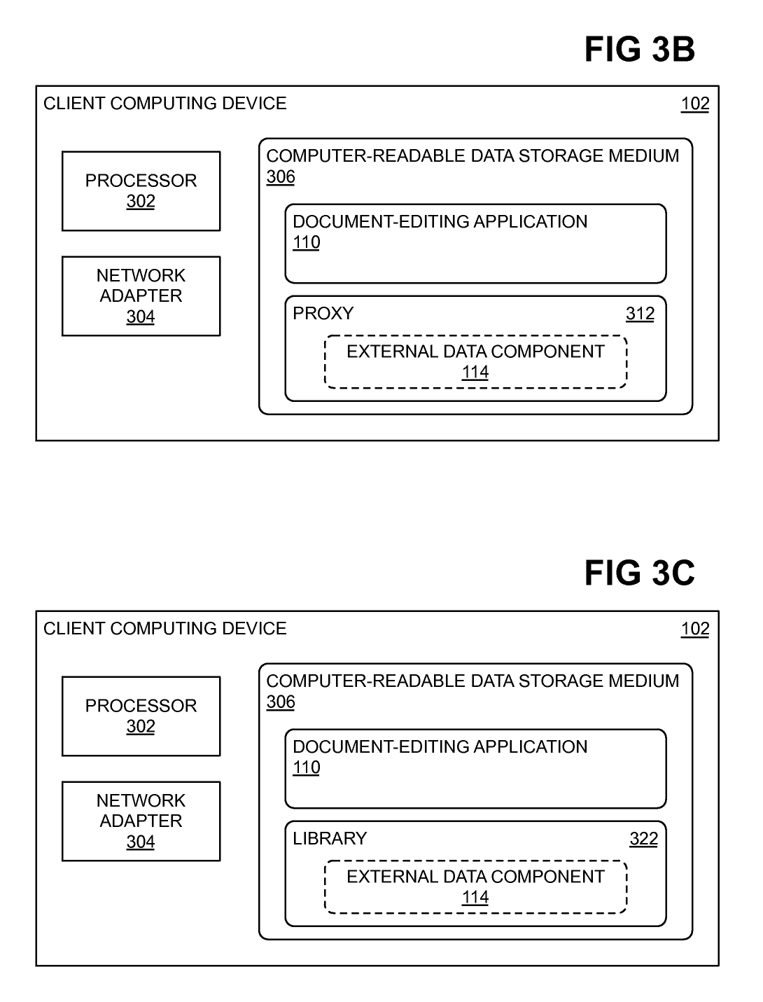

FIGS. 3A, 3B, and 3C show different example implementations of the client computing device 102. The client computing device 102 includes a processor 302, a network adapter 304, and a computer-readable data storage medium 306. The client computing device 102 can and typically does include other hardware, in addition to and/or in lieu of the processor 302, the network adapter 304, and the computer-readable data storage medium 306.

The network adapter 304 permits the client computing device 102 to communicate over the network 108 of FIG. 1. The computer-readable data storage medium 306 may be a non-volatile or a volatile non-transitory computer-readable data storage medium, such as dynamic random access memory, hard disk drives, solid state drives, and so on. The computer-readable data storage medium 306 stores the document-editing application 110 and the client-side external data component 114, which are each implemented as software that the processor 302 executes from the medium 306.

In the example implementation of FIG. 3A, the client-side external data component 114 is integrated as an embedded and integral component within the document-editing application 110. While this does mean that the document-editing application 110 has to be updated at least once to permit the document 112 of FIG. 1 to access the external source 106, the client-side external data component 114 is sufficiently general so that subsequent additions of different types or classes of data access modules 208 for access to different external sources 106 does not result in the component 114 have to be correspondingly updated. Stated another way, the document-editing application 110 is updated usually just once, to include the general functionality provided by the client-side external data component 114, in such a way that the component 114 is not particularly tied to any specific external source 106.

In the example implementation of FIG. 3B, the client-side external data component 114 is implemented as or as part of a proxy 312. While the proxy 312 is depicted in FIG. 3B as being external to the document-editing application 110, the proxy 312 can also be internal to the document-editing application 110 in an example implementation that is a merging of FIGS. 3A and 3B in at least some respect. In either such case, the proxy 312 intercepts calls to the external source 106 from the document 112 within the document-editing application 110, and routes them accordingly to the server-side external data component 116.

A difference between the example implementations of FIGS. 3A and 3B is thus how the document 112 accesses the external data 118 using the external data components 114 and 116. In the example implementation of FIG. 3A, where no proxy 312 is employed, the document 112 may have to be hardcoded in such a way that it takes advantage of the functionality afforded by the external data components 114 and 116. That is, the document 112 is aware to at least some extent that the external data components 114 and 116 are being used to provide the document 112 with access to the external data 118.

By comparison, in the example implementation of FIG. 3B, or in the example implementation of FIG. 3A modified per the example implementation of FIG. 3A such that the proxy 312 is internal to the document-editing application 110, the document 112 may not have any such awareness. For example, the document 112 may attempt to access the external source 106 via a network address directly, and not realize that a proxy 312 is effectively intercepting such requests for the external data 118. Using a proxy 312 may be desirable where there exists a well defined and frequently employed manner by which the external source 106 is accessed, so that a creator of the document 112 does not have to learn any new programmatic techniques to code the document 112 to retrieve the external data 118.

In the example implementation of FIG. 3C, the client-side external data component 114 is implemented as or as part of a library 322. The library 322 provides function calls that the document 112 within the document-editing application 110 can call or access to issue requests to the external data 118 stored on the external source 106. These function calls may be implemented as one or more application programming interfaces (APIs), for instance.

A difference between the example implementations of FIGS. 3A and 3C is thus the level of generality afforded by the respective implementations in providing new ways by which external data 118 stored on the external source 106 can be accessed. In the former implementation of FIG. 3A, the methods that the document 112 uses to access the external data 118 may be effectively hardcoded within the document-editing application 110 itself. New methods to access the external data 118 thus result in the document-editing application 110 having to be updated prior to the document 112 being able to leverage them.

By comparison, in the latter implementation of FIG. 3B, the methods that the document 112 uses to access the external data 118 are not hardcoded within the document-editing application 110 itself, but rather are externally stored within the library 322. New methods to access the external data 118 may not result in the document-editing application 110 itself having to be updated prior to the document 112 being able to leverage them. Rather, just the library 322 itself has to be updated to delineate these new methods and corresponding function calls. In general, updating the library 322, as opposed to the entire document-editing application 110, is an easier process, particularly where certain enterprises may lock the document-editing application 110 at a current version for relatively long lengths of time. In this case, upgrading the document-editing application 110 just to provide new methods by which the external data 118 can be accessed may not be an option, whereas upgrading just the library 322 itself may be.

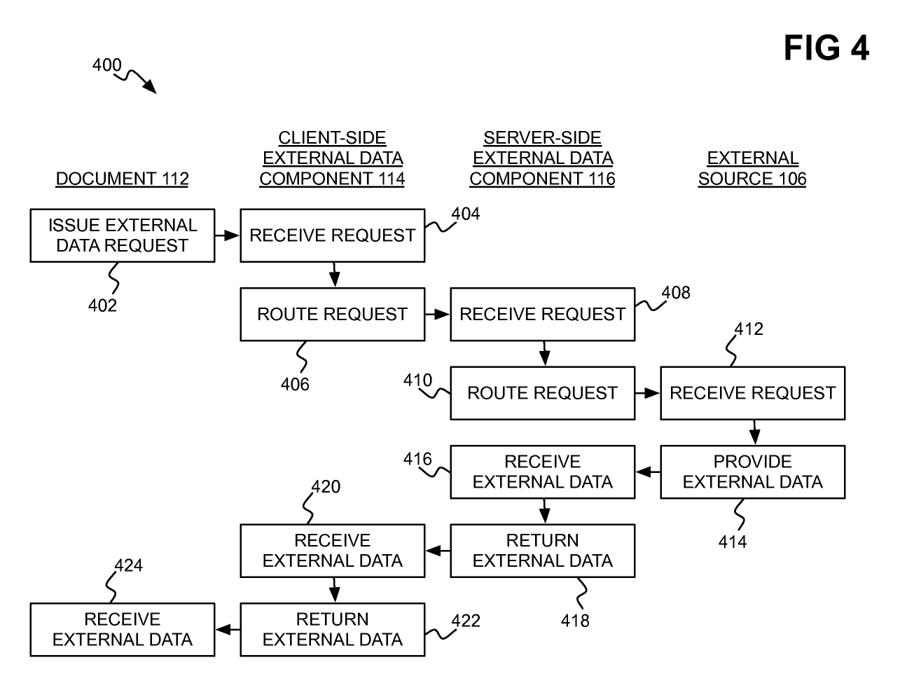

FIG. 4 shows an example method 400 as to how the example system 100 of FIG. 1, the components of which may be implemented per FIGS. 2 and 3A-3C, operates. The parts of the method 400 are divided over four columns, corresponding to the components that perform the parts in question. From left to right in FIG. 4, these components are the document 112 of the document-editing application 110, the client-side external data component 114, the server-side external data component 116 (such as a data access module 208 thereof), and the external source 106 storing the external data 118.

The method 400 can be implemented as a computer program executable by a processor of a suitable computing device. The computer program may be stored on a non-transitory computer-readable data storage medium, and executed by the processor from this medium. More specifically, the parts of the method 400 in each column can be implemented as a computer program executable by a processor of a corresponding component.

For instance, parts 402 and 424 can be implemented as a computer program executable by a processor of the client computing device 102 at which the document-editing application 110 including the document 112 is located. Parts 404, 406, 420, and 422 can be implemented as a computer program executable by a processor of the client computing device 102 at which the client-side external data component 114 is located. Parts 408, 410, 416, and 418 can be implemented as a computer program executable by a processor of the server computing device 104 at which the server-side external data component 116 is located. Parts 412 and 414 can be implemented as a computer program executable by a processor of a server computing device 104 that serves as the external source 106 of the external data 118.

The document 112 within the document-editing application 110 issues a request for the external data 118 stored on the external source 106 (402). The client-side external data component 114 receives the request (404), and routes the request to the server-side external data component 116 (406), such as to an already instantiated appropriate data access module 208 thereof. The server-side external data component 116 receives the request (408), and routes the request to the external source 106 (410). The external source 106 receives the request (412), and responsively provides the external data 118 that has been requested (414).

The server-side external data component 116 receives the external data 118 from the external source 106 (416), and returns the external data 118 to the client-side external data component 114 (418). The client-side external data component 114 likewise receives the external data 118 from the server-side external data component 116 (420), and returns the external data 118 to the document 112 (422). The document 112 within the document-editing application 110 thus receives the external data 118 that it had requested in part 402 (424).

We claim:

1. A system comprising:
a client computing device having a document-editing application program to edit a document, the document to issue a request to access external data stored on an external source for inclusion within the document;
a server computing device communicatively connected to the client computing device over a network;
a client-side external data component at the client computing device to receive and route the request to access the external data from the document and to return the external data responsively received to the request back to the document for inclusion within the document; and,
a server-side external data component at the server computing device to receive from the client-side external data component the request to access the external data, to route the request to the external source, and to return the external data responsively received to the request back to the client-side external data component.

2. The system of claim 1, wherein the server-side external data component comprises:
a data access module for the external source in relation to the client computing device, the data access module to receive from the client-side external data component the request to access the external data, to route the request to the external source, and to return the external data responsively received to the request back to the client-side external data component,
wherein the data access module is specific to the external source of the external data and not to other external sources of other external data,
and wherein the data access module is instantiated in relation to the client computing device and not in relation to other client computing devices requesting the external data stored on the external source.

3. The system of claim 2, wherein the server-side external data component further comprises:
a data access module manager to instantiate the data access module in relation to the client computing device where the data access module has not yet been instantiated in relation to the client computing device, and even where the data access module has been instantiated for the external source in relation to another client computing device.

4. The system of claim 3, wherein the data access module manager is to manage the data access module in relation to the client computing device, including terminating the data access module in relation to the client computing device responsive to determining that the client computing device is no longer using the data access module.

5. The system of claim 2, wherein the data access module is adapted to access the external source that is one of:
an external data source that is accessed in accordance with a Java Database Connectivity (JDBC) methodology;
an external data source that is an SAP data source.

6. The system of claim 1, wherein the client-side external data component is implemented as an embedded part within the document-editing application program.

7. The system of claim 1, wherein the client-side external data component is implemented as a proxy component.

8. The system of claim 7, wherein the proxy component is implemented as one of:
an embedded part within the document-editing application program;
an external component to the document-editing application program.

9. The system of claim 1, wherein the proxy component is implemented as a library of function calls.

10. A server computing device comprising:
a processor; and,
a computer-readable data storage medium storing a server-side external data component executable by the processor and comprising:
a data access module for an external source of external data, the data access module to receive from a client computing device a request to access the external data, to route the request to the external source, and to return the external data responsively received to the request back to the client-side external data component,
wherein the data access modulate is specific to the external source of the external data and not to other external sources of other external data.

11. The server computing device of claim 10, wherein the server-side external data component further comprises:
a data access module manager to instantiate the data access module in relation to the client computing device where the data access module has not yet been instantiated in relation to the client computing device, even where the data access module has been instantiated for the external source in relation to another client computing device,
such that the data access module is instantiated just for the client computing device to access the external data from the external source.

12. A non-transitory computer-readable data storage medium to store a computer program executable by a processor of a client computing device to implement a client-side external data component method at the client computing device and for a document-editing application program, the client-side external data component method comprising:
receiving a request issued by a document being edited within the document-editing application program, the request to access external data stored on an external source for inclusion within the document;
routing the request to a data access module for the external source, the data access module implemented at a server computing device, the data access module specific to the external source and not to other external sources of other external data, the data access module having been instantiated just for the client computing device and not for other client computing devices;
receiving the external data from the external source via the data access module implemented at the server computing device; and,
returning the external data back to the document for inclusion within the document.

13. The non-transitory computer-readable data storage medium of claim 12, wherein the client-side external data component is implemented as an embedded part within the document-editing application program.

14. The non-transitory computer-readable data storage medium of claim 12, wherein the client-side external data component is implemented as a proxy component, as one of:
an embedded part within the document-editing application program;
an external component to the document-editing application program.

15. The non-transitory computer-readable data storage medium of claim 12, wherein the proxy component is implemented as a library of function calls.
